(19) United States
(12) Patent Application Publication
(10) Pub. No.: US 2023/0405504 A1
(43) Pub. Date: Dec. 21, 2023

(54) FILTER ELEMENT, FILTER ELEMENT ARRANGEMENT, AND FILTER SYSTEM WITH A FILTER ELEMENT ARRANGEMENT

(71) Applicant: MANN+HUMMEL GmbH, Ludwigsburg (DE)

(72) Inventors: Adriano HORIYE, Ludwigsburg (DE); Irmgard THALMANN, Waiblingen (DE); Sharat BHUTI, Karnataka (IN)

(21) Appl. No.: 18/461,094

(22) Filed: Sep. 5, 2023

Related U.S. Application Data
(63) Continuation of application No. PCT/EP2022/054935, filed on Feb. 28, 2022.

(30) Foreign Application Priority Data
Mar. 4, 2021 (DE) 102021105231.9

(51) Int. Cl. B01D 46/10; B01D 46/00

(52) U.S. Cl. CPC B01D 46/10; B01D 46/0005; B01D 2275/201; B01D 2201/304

(57) ABSTRACT

A first filter element has a filter medium body for radial fluid flow therethrough and first and second end plates at opposed end faces of the filter medium body. A first engagement device extending axially parallel to a longitudinal axis of the filter medium body is arranged at the first end plate. A second filter element has a filter medium body and a seal device for radially sealing the second filter element in a filter housing. A fluid flow through the second filter element is perpendicular to a plane spanned by the seal device. The seal device has a second engagement device extending axially perpendicularly to the plane spanned by the seal device. The filter elements are axially joined to a filter element arrangement, wherein the first and second engagement devices engage each other. A filter system has such a filter element arrangement arranged in a filter housing.

### CROSS-REFERENCE TO RELATED APPLICATIONS

This application is a continuation application of international application No. PCT/EP2022/054935 having an international filing date of 28 Feb. 2022 and designating the United States, the international application claiming a priority date of 4 Mar. 2021 based on prior filed German patent application No. 10 2021 105 231.9, the entire contents of the aforesaid international application and the aforesaid German patent application being incorporated herein by reference.

### BACKGROUND OF THE INVENTION

The invention concerns a filter element, a filter element arrangement as well as a filter system with a filter element arrangement, in particular for gas filtration.

DE 10 2016 004 316 A1 describes an air filter device for an internal combustion engine comprising a main filter element and a secondary element in a filter housing. The secondary filter element serves primarily for preventing a contamination of a clean side of the filter element arrangement with raw fluid to be filtered when exchanging the main filter element.

The main filter element comprises an annularly closed filter medium body whose wall is flowed though by the fluid to be purified in radial direction from the exterior to the interior. The fluid to be purified flows through the wall of the filter medium body in radial direction in relation to its longitudinal axis. The axial end faces of the filter medium body are covered seal-tightly by end plates. One end plate comprises a central opening communicating with the inwardly positioned flow space for the axial flow conduction of the fluid; the oppositely positioned end plate, on the other hand, is of a closed configuration and closes off the inwardly positioned flow space axially seal-tightly relative to the exterior. At the end plate which is of an open configuration, a ring is integrally formed which extends axially outwardly and seals and supports the filter element at the filter housing in the mounted state.

The secondary element comprises a plate with a circumferentially extending seal for radial sealing in relation to the filter housing. For positioning the secondary element within the ring at the end plate of the main element, the secondary element comprises radially projecting engagement sections at the circumference of the plate, with which it engages with form fit in corresponding counter engagement sections in the end plate of the main filter element.

### SUMMARY OF THE INVENTION

It is an object of the invention to create an improved filter element, in particular an improved main element and/or an improved secondary element.

A further object of the invention is to provide a filter element arrangement with at least one improved filter element.

A further object of the invention is to provide a filter system with an improved filter element arrangement.

The aforementioned objects are solved according to an aspect of the invention with a filter element, in particular main element, in particular for gas filtration, with a filter medium body whose wall can be flowed through by the fluid to be purified in radial direction in relation to a longitudinal axis of the filter medium, with an end plate arranged at the oppositely positioned end faces of the filter medium body, respectively. At one end face of one of the end plates, at least one engagement means extending in axial direction parallel to the longitudinal axis is provided for contacting a further filter element following in axial direction.

According to a further aspect of the invention, the objects are solved by a filter element, in particular secondary element, in particular for gas filtration, with a filter medium body and a seal device for radial sealing of the filter element in relation to a filter housing, wherein a flow direction of a fluid to be filtered through the filter medium body is positioned perpendicularly to a plane which is spanned by the seal device. The seal device comprises at least one engagement means extending in axial direction perpendicularly to the plane.

According to a further aspect of the invention, the objects are solved by a filter element arrangement, with a first filter element, in particular main element, with a first filter medium body whose wall can be flowed through by the fluid to be purified in radial direction in relation to a longitudinal axis of the filter medium body, with an end plate arranged at the oppositely positioned end faces of the filter medium body, respectively, and with a second filter element, in particular secondary element, with a second filter medium body, and a seal device for radial sealing of the filter element in relation to a filter housing, wherein a flow direction of a fluid to be filtered through the second filter medium body is positioned perpendicularly to a plane which is spanned by the seal device. At a first end face of one of the end plates of the first filter element, at least one first engagement means extending in axial direction parallel to the longitudinal axis is provided, and the seal device comprises at least one second engagement means extending in axial direction perpendicularly to the plane, wherein the engagement means engage each other.

According to a further aspect of the invention, the object is solved by a filter system with a housing in which a filter element arrangement with a first filter element and a second filter element is arranged so as to be exchangeable. At a first end face of one of the end plates of the first filter element, at least one first engagement means extending in axial direction parallel to a longitudinal axis is provided, and a seal device of the second filter element comprises at least one second engagement means extending in axial direction perpendicularly to a plane which is spanned by the seal device, wherein the engagement means engage each other.

Beneficial embodiments and advantages of the invention result from the additional claims, the description, and the drawing.

According to an aspect of the invention, a filter element, in particular main element, in particular for gas filtration, is proposed with a filter medium body whose wall can be flowed through by the fluid to be purified in radial direction in relation to a longitudinal axis of the filter medium body, with an end plate arranged at the oppositely positioned end faces of the filter medium body, respectively. At one end face of one of the end plates, at least one engagement means extending in axial direction parallel to the longitudinal axis is provided for contacting a further filter element.

Advantageously, the at least one engagement means permits a stable support and positioning of the filter element, in particular main element, in a housing in that it can be supported at an axially following filter element, in particular secondary element. Advantageously, no separate radial support means are required in order to protect the main element in the housing from vibrations in operation. An insertion of the filter element into the housing can be facilitated in this way.

Advantageously, the filter element can be configured as a round filter element in which the filter medium body surrounds as a closed ring an interior. The round filter element comprises an axial extension and perpendicularly thereto a cross section which can be circular, oval or angular. The fluid to be purified passes in radial direction, i.e., transversely to the axial extension, through the filter medium body or the filter medium. Advantageously, an end plate can be open toward the interior and the oppositely positioned end plate can be closed. The interior can form a raw side of the filter element so that the fluid to be purified flows from the interior to the exterior through the filter medium body. The clean side surrounds correspondingly the filter element. Alternatively, the interior can form a clean side of the filter element so that the fluid to be purified flows from the exterior through the filter medium body into the interior.

The filter medium of the filter medium body can be folded so that fold edges are lying in the circumferential surface of the filter medium body. Alternatively, the filter medium can be embodied as a coil which is provided with one or a plurality of layers resting on each other. The filter medium can be a filter fabric, laid filter or a filter nonwoven. In particular, the filter medium can be produced by a spunbond nonwoven method or melt-blowing method. Furthermore, the filter medium can be felted or needled. The filter medium can comprise natural fibers, such as cellulose or cotton, or synthetic fibers, for example, of polyester, polyvinyl sulfite or polytetrafluoroethylene. The fibers can be oriented during processing in, at a slant to and/or transversely to the machine direction. Also, the filter medium body can be formed of a combination of different filter media.

The at least one engagement means can be provided as a recess in the end plate which can be engaged by an engagement means of the other filter element. Alternatively, the at least one engagement means can be provided as a pin which engages a corresponding engagement means of the other filter element.

According to a beneficial embodiment, the engagement means can be arranged at an end face with closed end plate. Advantageously, the interior of the filter element can form the raw side.

According to a beneficial embodiment, the engagement means can be formed as a recess. In particular, the engagement means can be embodied as a recess in a rim region of the end plate. This region is particularly stable.

A recess can be designed as an opening or depression surrounded by a material or as a type of groove, for example, in U-shape or V-shape, in a material with an open side facing outwardly in radial direction.

According to a beneficial embodiment, the engagement means can be arranged in a region of the end plate in which the filter medium or the filter medium body is embedded. This region is particularly stable so that damages to the end plate can be prevented when pushing together two filter elements.

According to a beneficial embodiment, the at least one engagement means can be provided as a recess in a frame, in particular of a plastic material, of a filter element which can be engaged by an engagement means of the other filter element. Alternatively, the at least one engagement means can be provided as a pin which engages in a corresponding engagement means of the other filter element.

According to a further aspect of the invention, a filter element, in particular secondary element, in particular for gas filtration, is proposed with a filter medium body and a seal device for radial sealing of the filter element in relation to a filter housing, wherein a flow direction of a fluid to be filtered through the filter medium body is positioned perpendicularly to a plane spanned by the seal device. The seal device comprises at least one engagement means extending in axial direction perpendicularly to the plane.

Advantageously, the at least one engagement means permits a stable support and positioning of a filter element, in particular main element, at the filter element, in particular secondary element, in a housing. Advantageously, no separate radial support means are required in order to protect the main element in the housing from vibrations in operation. An insertion of the filter element, in particular main element, into the housing can be facilitated thereby.

The cross section of the filter element, in particular secondary element, can be circular, oval or angular. In particular, the cross section can be configured to match the cross section of the other filter element.

The filter medium of the filter medium body can be folded so that the fold edges are lying in an end face of the filter medium body. Alternatively, the filter medium can be designed in layers, wherein one or a plurality of layers resting on each other can be provided. The filter medium can be a filter fabric, laid filter, or a filter nonwoven. In particular, the filter medium can be produced by a spunbond nonwoven method or melt-blowing method. Furthermore, the filter medium can be felted or needled. The filter medium can comprise natural fibers, such as cellulose or cotton, or synthetic fibers, for example, of polyester, polyvinyl sulfite, or polytetrafluoroethylene. The fibers can be oriented during processing in, at a slant to and/or transversely to the machine direction. Also, the filter medium body can be formed of a combination of different filter media.

The at least one engagement means can be designed as a pin. Alternatively, the at least one engagement means can be designed as a recess.

According to a beneficial embodiment, the at least one engagement means can be arranged in a region of the seal device outside of the filter medium. In particular, the seal device can be embodied as a plate with a circumferentially extending seal. This positioning of the at least one engagement means permits an undisturbed function of the filter medium. The plate comprises a plurality of openings so that the filter medium body can rest thereon stably and fluid can flow through the filter medium body and the plate. Preferably, the plate can have a type of grid structure with a rim circumferentially extending in the region of the seal. The plate can be manufactured preferably of a strong plastic material, for example, polyamide.

According to a beneficial embodiment, the at least one engagement means can be configured as a pin. In particular, the at least one engagement means can comprise a demounting aid. Advantageously, a distance between axially adjoining filter elements can be adjusted by a length of the pin. The demounting aid enables a simple release of the plug-in connection between the filter element, in particular secondary element, and a further filter element, in particular main element, which is in contact with the engagement means. In a beneficial embodiment, the demounting aid is embodied with a cutout in the form of an undercut in order to be able to apply with form fit a demounting force by means of a tool or manually.

According to a further aspect of the invention, a filter element arrangement is proposed with a first filter element, in particular main element, with a first filter medium body whose wall can be flowed through by the fluid to be purified in radial direction in relation to a longitudinal axis of the filter medium body, with an end plate arranged at the oppositely positioned end faces of the filter medium body, respectively, and with a second filter element, in particular secondary element, with a second filter medium body and a seal device for radial sealing of the second filter element in relation to the filter housing, wherein a flow direction of the fluid to be filtered through the second filter medium body is positioned perpendicularly to a plane spanned by the seal device. At a first end face of one of the end plates of the first filter element, at least one engagement means extending in radial direction parallel to the longitudinal axis is provided, and the seal device of the second filter element comprises at least one second engagement means extending in axial direction perpendicularly to the plane, wherein the first and second engagement means engage each other.

Advantageously, the at least one engagement means permits a stable support and positioning of the first filter element, in particular main element, at the second filter element, in particular secondary element, in the housing. Advantageously, no separate radial support means are required in order to protect the first filter element in the housing from vibrations in operation. An insertion of the first filter element into the housing can be facilitated in this way.

The first filter element, in particular the main element, can push the further filter element, in particular the secondary element, in axial direction into the end position and fix the further filter element in the operating position. The further filter element delimits the freedom of movement of the filter element in axial direction and radial direction.

Advantageously, the second filter element can remain in the housing when the first filter element is exchanged. As needed, the second filter element can be exchanged also.

According to a beneficial embodiment, for joined first and second filter elements, the end face of the end plate with the at least one first engagement means can be spaced apart by a clearance from a second end face of the second filter element facing the first end face. Advantageously, the clearance can be adjusted by means of the engagement means.

According to a further aspect of the invention, a filter system, in particular for air filtration, is proposed, with a housing in which a filter element arrangement with a first filter element and a second filter element is exchangeably arranged. At a first end face of one of the end plates of the first filter element, at least one engagement means extending in axial direction parallel to a longitudinal axis is provided. A seal device of the second filter element comprises at least one second engagement means extending in axial direction perpendicularly to the plane spanned by the seal device, wherein the first and second engagement means engage each other.

According to a beneficial embodiment, the housing can comprise in a housing part at least one housing engagement means at which the second filter element can be mounted, in particular can be pushed on or inserted.

Beneficially, the second filter element can be positioned stably and vibration-proof in the housing.

According to a beneficial embodiment, the at least one second engagement means and the at least one housing engagement means can engage each other. A secure positioning of the second filter element is enabled.

According to a beneficial embodiment, the at least one housing engagement means can be configured as a pin extending in axial direction and engaging an opening of the at least one second engagement means. Optionally, the secondary element can comprise as an engagement means a pin which can project into the housing engagement means when the latter is configured as a recess.

### BRIEF DESCRIPTION OF THE DRAWINGS

Further advantages result from the following drawing description. In the drawings, embodiments of the invention are illustrated. The drawings, the description, and the claims contain numerous features in combination. A person of skill in the art will consider the features expediently also individually and combine them to expedient further combinations.

FIG. 1 shows in perspective view a filter system in exploded illustration according to an embodiment of the invention.

FIG. 2 shows in a longitudinal section the filter system according to FIG. 1 in exploded illustration.

FIG. 3 shows a detail view of a filter arrangement in a partially sectioned housing according to FIG. 1.

FIG. 4 shows a detail view of the filter arrangement according to FIG. 3.

FIG. 5 shows a longitudinal section of the filter system according to FIG. 1 with filter element inserted in the housing in end position.

### DESCRIPTION OF PREFERRED EMBODIMENTS

In the Figures, same or same-type components are identified with same reference characters. The Figures show only examples and are not to be understood as limiting.

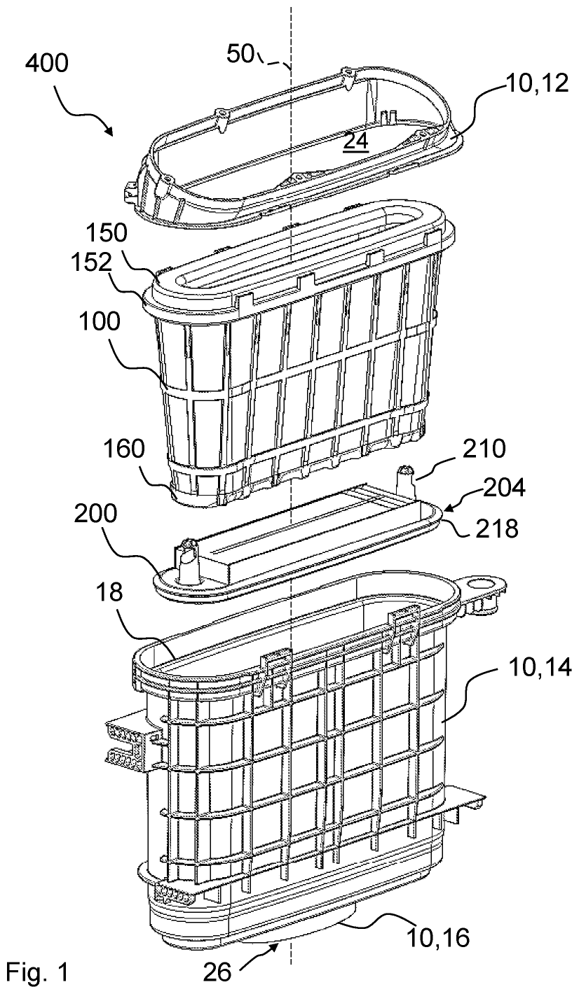

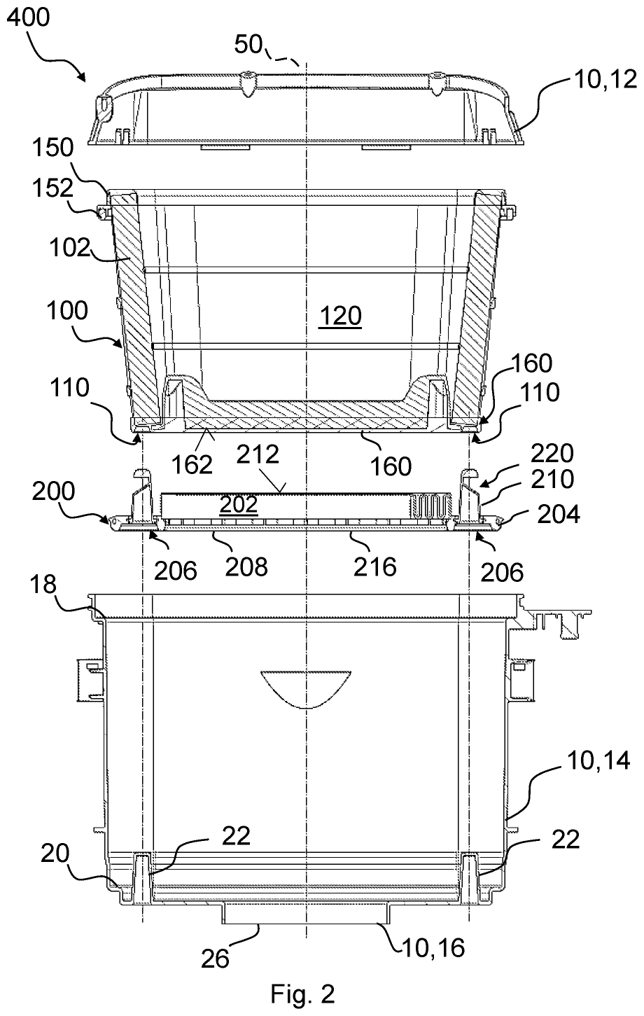

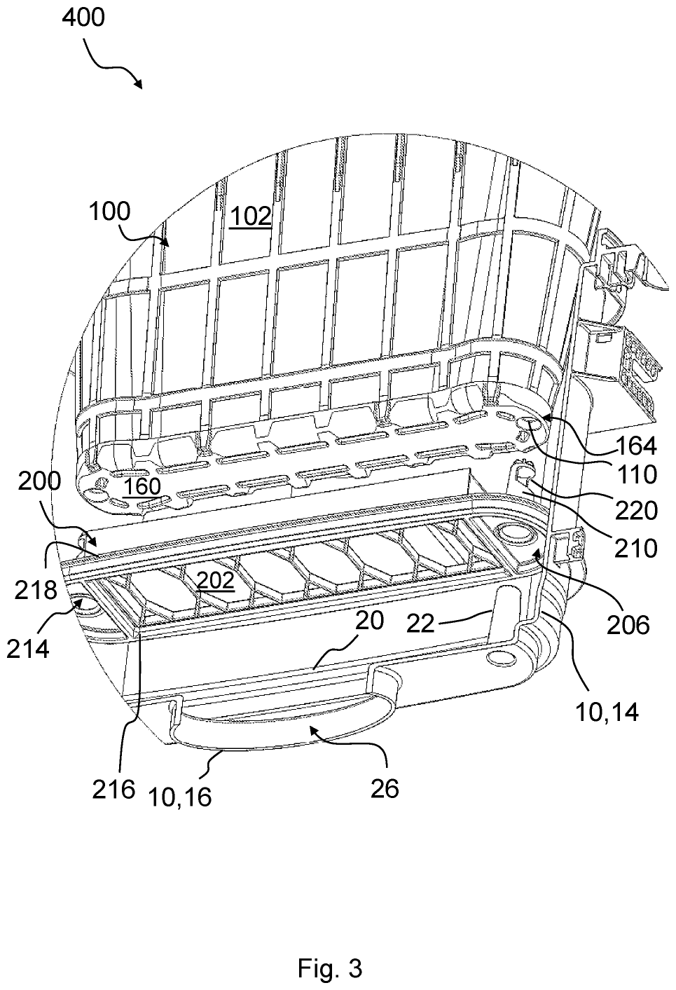

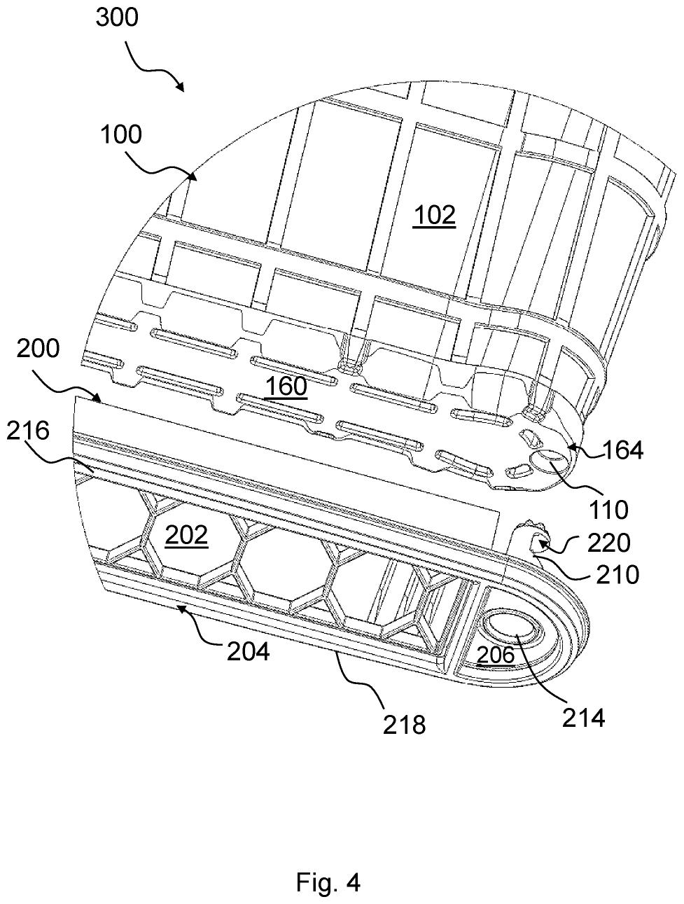

In order to explain the invention, FIG. 1 shows, in perspective view, an embodiment of a filter system 400 with a first and a second filter element 100, 200 in a housing 10 in exploded illustration, while FIG. 2 shows the filter system 400 illustrated in exploded illustration in a longitudinal section. FIG. 3 shows a detail view of the filter element arrangement 300 of the filter elements 100, 200 in partially sectioned housing 10, and FIG. 4 shows a detail view of the filter element arrangement 300 according to FIG. 3.

The filter system 400 serves, for example, for gas filtration, in particular for air filtration. The filter system 400 comprises a housing 10 with a first housing part 12 and a second housing part 14. The first housing part 12 is configured here as a hood and comprises a fluid inlet 24 in this example. The second housing part 14 is configured here as a housing pot and comprises at the bottom a socket 16 which comprises a fluid outlet 26.

In the housing 10, a filter element arrangement 300 is arranged in the flow path of the fluid, with a first filter element 100 which forms a main element, and a second filter element 200 which forms a secondary element. The filter elements 100, 200 are arranged following each other in longitudinal direction 50. Both filter elements 100, 200 can be provided so as to be exchangeably arranged.

The first filter element 100 is embodied as a round filter element with a closed filter medium body 102 of a filter medium and comprises in the longitudinal direction 50 an oval cross section, for example. The cross section can decrease beginning at an end plate 150 in direction toward the end plate 160 so that the first filter element 100 tapers conically. Preferably however, the first filter element 100 comprises an oval or elliptical cross section. The first filter element 100 comprises an oval base surface. Alternatively, the cross section can have a rectangular cross section with rounded corners, an elliptical cross section, or a cross section which is formed of a plurality of circular arcs. The first filter element 100 can comprise a central tube which delimits an interior space 120 of the first filter element 100.

The filter medium of the filter medium body 102 is folded, for example, such that the outer fold edges are lying in an outer circumferential surface and inner fold edges in an inner circumferential surface. The fold ends are embedded in the respective end plates 150, 160.

The end plates 150, 160 can be fused, glued or welded to the filter medium.

The open end plate 150 of the first filter element 100 can be clamped stably between the first housing part 12 and the second housing part 14 when the first housing part 12 is connected to the second housing part 14. The end plate 150 is seated on a shoulder 18 of the second housing part 14 and, in this context, radially and/or axially seals with a circumferential collar 152 raw side relative to clean side.

The end plate 150 of the first filter element 100 is of an open configuration and is arranged, for example, as a ring of foamed polyurethane (PUR) at the filter medium body 102. The end plate 160 is closed fluid-tightly. The end plate 160 can be formed of plastic material, for example, of PUR.

At an outer end face 162 of the end plate 160 of the first filter element 100, two engagement means 110 extending in axial direction parallel to the longitudinal axis 50 are provided. The engagement means 110 are embodied as recesses in the end plate 160 and arranged in the rim region 164 thereof in a region where the filter medium or the filter medium body 102 is embedded.

The interior 120 of the first filter element forms in this example the raw side of the filter element 100. The fluid to be purified flows through the fluid inlet 24 of the first housing part 12 into the first filter element 100 and passes radially through the filter medium body 102 into the outer region of the filter element 100.

The second filter element 200 is configured as a flat filter with a filter element body 202 which, for example, is folded and is arranged on a seal device 204. The seal device 204 comprises a plate 216 surrounded by a seal 218 extending circumferentially about the rim so that the second filter element can be sealed radially in relation to the housing 10. Outer fold edges of the filter medium are lying in an end face 212 which is facing the first filter element 100, while the inner fold edges adjoin the plate 216. The filter medium can be over-molded or can be sealed by a strip.

The seal device 204 of the second filter element 200 comprises two second engagement means 210 in the form of pins extending in axial direction perpendicularly to a plane 208 spanned by the seal device 204, wherein the engagement means 110 of the first filter element 100 and the engagement means 210 of the second filter element 200 engage each other when the two filter elements 100, 200 are joined as a filter element arrangement 300.

The engagement means 210 are arranged in a region 206 of the seal device 204 outside of the filter medium body 202. The plate 216 comprises a plurality of openings so that the filter medium body 202 can stably rest thereon and fluid can flow through the filter medium body 202 and the plate 216.

The pin-shaped engagement means 210, as can be seen in FIGS. 3 and 4, are of a hollow configuration so that the pin-shaped housing engagement means 22 at the bottom of the housing part 14 of the housing 10 can engage an opening 214 at their base.

The pin-shaped engagement means 210 of the second filter element 200 comprise at their circumference a demounting aid 220 embodied as a cutout so that the second filter element 200, as needed, can be pulled off the housing engagement elements 22, for example, when exchanging the second filter element 200.

The fluid to be purified enters the filter system 400 and the interior 120 of the first filter element 100 through a fluid inlet 24, flows radially through the filter medium body 102 of the filter element 100 into the external space between housing and filter medium body 102, through the free space formed by the clearance 302 to the second filter element 200, and flows through its filter medium body 202 to the fluid outlet 26 in the socket 16.

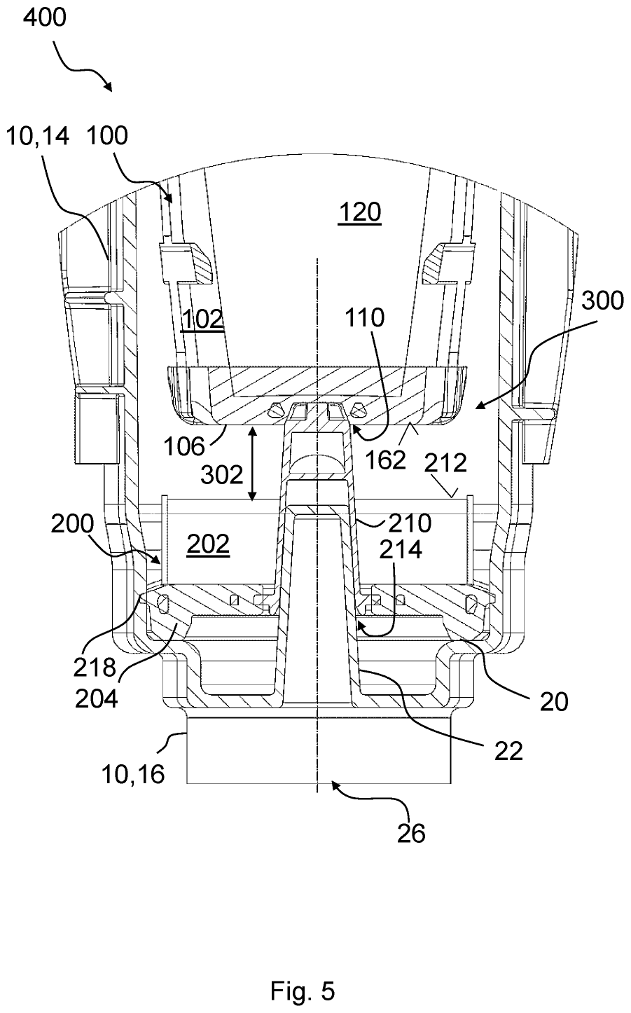

FIG. 5 shows a longitudinal section of the filter system 400 according to FIG. 1 with filter elements 100, 200 inserted in end position in the housing 10.

The second filter element 200 has been inserted all the way to the bottom of the second housing part 14 of the housing 10 and is seated on a shoulder of the housing part 14 above the socket 16 comprising the fluid outlet 26 and seals with its seal 218, circumferentially surrounding the plate 216 of the seal device 204, in relation to the inner side of the housing part 14. In this context, the second filter element 200 is fixedly seated with its engagement means 210 stably on the pin-shaped housing engagement means 22 at the bottom of the housing 10. The housing engagement means 22 guide the second filter element 200 upon insertion into the housing 10 and fix the second filter element 200 in operation of the filter system 400.

The first filter element 100 is placed on top of the second filter element 200. The engagement means 210 of the second filter element 200 engage in this context in the engagement means 110 of the first filter element 100 embodied as recess. When the first and second filter elements 100, 200 are joined in the end position in the housing 10, the end face 162 of the end plate 160 is spaced apart in relation to the second end face 212 of the second filter element 200 at a clearance 302.

The second filter element 200 supports in this context the first filter element by means of the engagement means 210 and, due to its stable fixation at the housing engagement means 22, reliably prevents movements of the first filter element 100, even in case of vibrations in operation of the filter system 400.

What is claimed is:

1. A filter element comprising:
a filter medium body comprising a wall configured to be flowed through by a fluid to be purified in a radial direction in relation to a longitudinal axis of the filter medium body, wherein the filter medium body comprises oppositely positioned end faces;
a first end plate and a second end plate arranged at the oppositely positioned end faces of the filter medium body;
at least one engagement means extending in an axial direction parallel to the longitudinal axis and arranged at an end face of the first end plate, wherein the at least one engagement means is configured to contact a further filter element to be arranged adjacent to the first end plate in the axial direction.

2. The filter element according to claim 1, wherein the first end plate is a closed end plate.

3. The filter element according to claim 1, wherein the at least one engagement means is a recess.

4. The filter element according to claim 3, wherein the recess is arranged in a rim region of the first end plate.

5. The filter element according to claim 1, wherein the filter medium body is embedded in a region of the first end plate, wherein the at least one engagement means is arranged in said region of the first end plate.

6. A filter element comprising:
a filter medium body;
a seal device configured to radially seal the filter element in relation to a filter housing;
wherein a flow direction of a fluid to be filtered through the filter medium body is positioned perpendicularly to a plane spanned by the seal device;
wherein the seal device comprises at least one engagement means extending in an axial direction perpendicularly to the plane spanned by the seal device.

7. The filter element according to claim 6, wherein the seal device comprises a region outside of the filter medium body, wherein the at least one engagement means is arranged in said region of the seal device outside of the filter medium body.

8. The filter element according to claim 6, wherein the seal device comprises a plate with a circumferentially extending seal.

9. The filter element according to claim 6, wherein the at least one engagement means is a pin.

10. The filter element according to claim 6, wherein the at least one engagement means comprises a demounting aid.

11. A filter element arrangement comprising:
a first filter element comprising:
a first filter medium body comprising a wall configured to be flowed through by a fluid to be purified in a radial direction in relation to a longitudinal axis of the first filter medium body, wherein the first filter medium body comprises oppositely positioned end faces;
a first end plate and a second end plate arranged at the oppositely positioned end faces of the first filter medium body;
at least one first engagement means extending in an axial direction parallel to the longitudinal axis and arranged at a first end face of the first end plate;
a second filter element comprising:
a second filter medium body;
a seal device configured to radially seal the second filter element in relation to a filter housing;
wherein a flow direction of a fluid to be filtered through the second filter medium body is positioned perpendicularly to a plane spanned by the seal device;
wherein the seal device comprises at least one second engagement means extending in the axial direction perpendicularly to the plane spanned by the seal device;
wherein the at least one first engagement means and the at least one second engagement means engage each other.

12. The filter element arrangement according to claim 11, wherein, when the first and second filter elements are joined, the first end face of the first end plate is spaced apart at a clearance from a second end face of the second filter element facing the first end face of the first end plate.

13. A filter system comprising:
a housing;
a filter element arrangement according to claim 11 exchangeably arranged in the housing.

14. The filter system according to claim 13, wherein the housing comprises a housing part comprising at least one housing engagement means, wherein the second filter element is configured to be mounted on the at least one housing engagement means.

15. The filter system according to claim 14, wherein the second filter element is configured to be pushed on the at least one housing engagement means or inserted into the at least one housing engagement means.

16. The filter system according to claim 14, wherein the at least one second engagement means of the seal device of the second filter element and the at least one housing engagement means engage each other.

17. The filter system according to claim 16, wherein the at least one housing engagement means is a pin extending in the axial direction and engaging an opening of the at least one second engagement means of the seal device of the second filter element.
